(19) United States
(12) Patent Application Publication
(10) Pub. No.: US 2011/0305901 A1
(43) Pub. Date: Dec. 15, 2011

(54) NONWOVEN HIGHWAY MARKING TAPE AND METHOD OF MANUFACTURING

(76) Inventors: Sanford Wyse, Archbold, OH (US); Chester Cromwell, Jerome, MI (US); Jill Marie Wyse, West Unity, OH (US); Lynn Dean Wyse, West Unity, OH (US); William Eric Rowley, Lewiston, MI (US)

(21) Appl. No.: 13/160,170

(22) Filed: Jun. 14, 2011

Related U.S. Application Data
(60) Provisional application No. 61/397,478, filed on Jun. 14, 2010.

(51) Int. Cl. B32B 7/12; B05D 1/36

(52) U.S. Cl. 428/352; 428/354; 427/402

(57) ABSTRACT

A marking tape includes a fibrous, non-woven base material having a first side and a second side opposite the first side. A seal coat saturates a portion of the fibrous, non-woven base material and provides a relatively non-porous coat surface. A carrier coat is applied to the coat surface, and a reflective material is applied to the carrier coat. The relatively non-porous coat surface is adapted to help prevent movement of the reflective material into the fibrous, non-woven base material. An adhesive applied to the second side.

### CROSS-REFERENCE TO RELATED APPLICATIONS

This application claims the benefit of U.S. Provisional Application No. 61/397,478, filed Jun. 14, 2010, the disclosure of which is incorporated herein by reference.

### BACKGROUND OF THE INVENTION

This invention relates in general to a tape for marking roads. In particular, this invention relates to a reflective highway tape. On roads, including highways, reflective tapes are used to mark things such as lane divisions and shoulders. These reflective tapes help people driving on the roads to locate and identify the marks at night time.

### SUMMARY OF THE INVENTION

This invention relates to a marking tape. The marking tape includes a fibrous, non-woven base material having a first side and a second side opposite the first side. A seal coat saturates a portion of the fibrous, non-woven base material and provides a relatively non-porous coat surface. A carrier coat is applied to the coat surface, and a reflective material is applied to the carrier coat. The relatively non-porous coat surface is adapted to help prevent movement of the reflective material into the fibrous, non-woven base material. An adhesive applied to the second side.

This invention further relates to a method of making a marking tape. The method includes applying a seal coat to a first side of a fibrous, non-woven base material such the seal coat saturates a portion of the base material and such that the seal coat forms a relatively non-porous coat surface. Further, applying a carrier coat to the relatively non-porous coat surface and applying a reflective material to the carrier coat, wherein the relatively non-porous coat surface is adapted to help prevent movement of the reflective material into the fibrous, non-woven base material. Additionally, the method includes applying an adhesive to a second side of the fibrous, non-woven base material.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a partially-unrolled marking tape.

FIG. 2 is a schematic, cross-sectional view taken along line 2-2 of FIG. 1.

FIG. 3 is a schematic view of a portion of a method suitable to make the marking tape of FIG. 1.

FIG. 4 is a schematic view of another portion of the method suitable to make the marking tape of FIG. 1.

### DETAILED DESCRIPTION OF THE PREFERRED EMBODIMENT

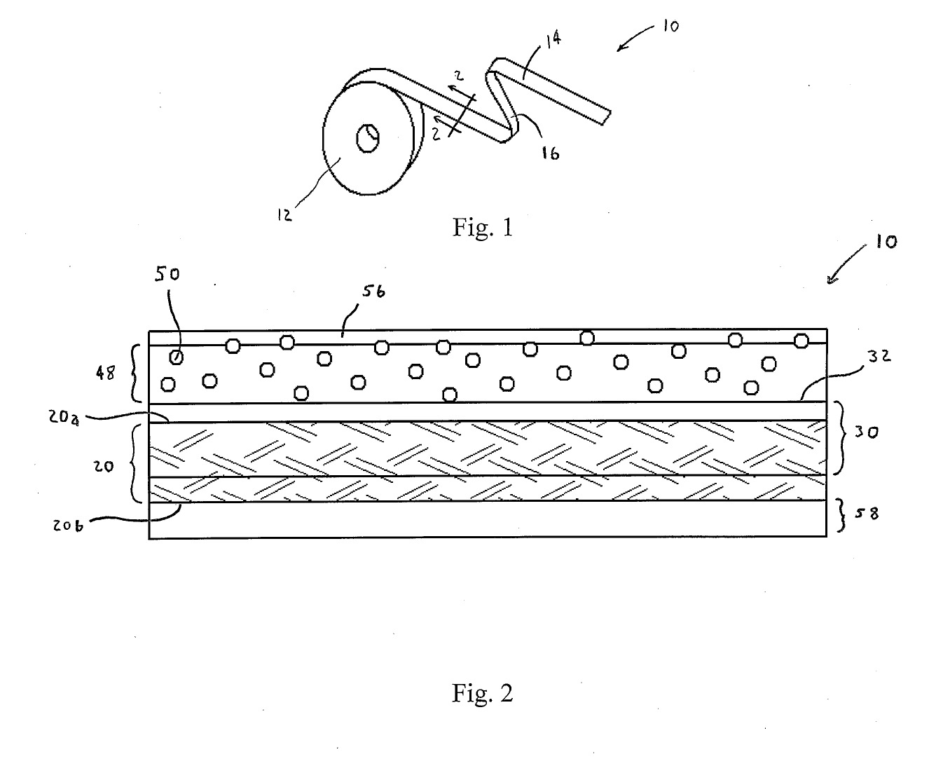

Referring now to the drawings, there is illustrated in FIG. 1 a marking tape, indicated generally at 10. The marking tape 10 is shown in a roll 12, and is shown with a portion of the marking tape 10 unrolled from the roll 12. The marking tape 10 is a flexible tape and has a reflective side 14 and an adhesive side 16. The marking tape 10 is suitable for use on highways or other surfaces on which a reflective marker is desired.

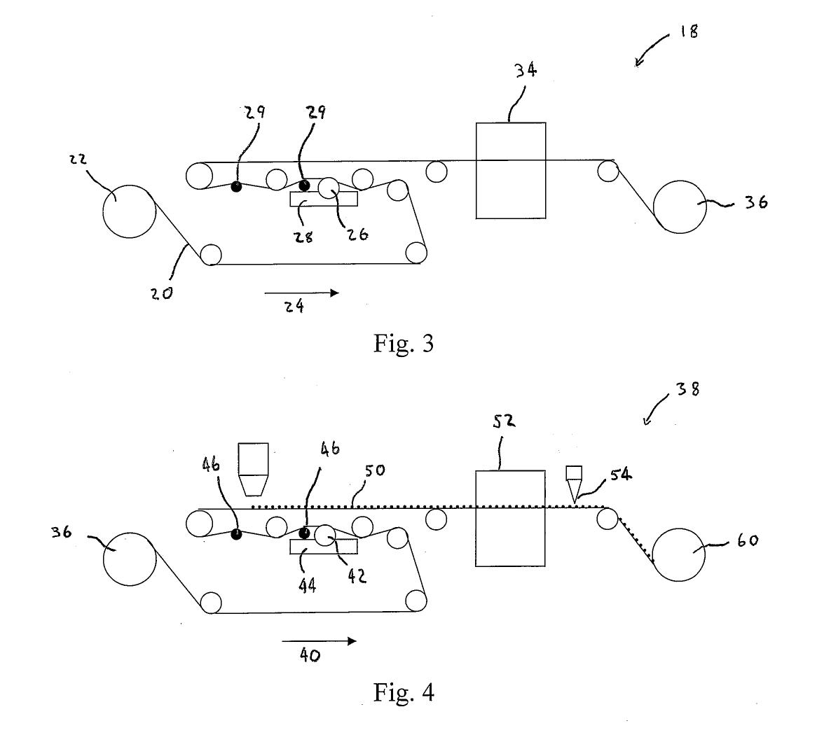

Referring to FIG. 2, a schematic cross-sectional view of the marking tape 10, taken along the line 2-2 of FIG. 1, is shown. As can be seen, the marking tape 10 is made of multiple layers of materials. It should be appreciated that the layers shown in FIG. 2 are not shown to scale. The layers comprising the marking tape 10 will be explained in reference to FIG. 3 and FIG. 4, which illustrate one method of making the marking tape 10.

Referring now to FIG. 3, a schematic view of a Meyer Rod coating procedure is shown generally at 18. The coating procedure 18 is one step in a method suitable to create the marking tape 10. The coating procedure 18 applies a coating to a base material 20. In the illustrated embodiment, the base material 20 is a conventionally formed fibrous, non-woven web. The illustrated base material 20 is made of polyester fibers exhibiting machine direction and cross-machine direction tensile strengths of at least 90 pound. The base material 20 includes a web basis weight of 135 grams per square meter and has been calendared. The fiber deniers are in the 3-5 range. Other materials that provide the desired strength and flexibility may be used, if desired.

In the illustrated coating procedure 18, the base material 20 is unwound from a roll 22 and fed in the direction indicated by the arrow 24. The base material 20 has a first side 20a and a second side 20b, opposite the first side 20a. The base material 20 is passed over a coating roller 26 where a seal coat material 28 is applied to the first side 20a. Meyer rods 29 are used to control the thickness of the layer of the seal coat material 28 on the base material 20. In the illustrated coating procedure 18, the seal coat material 28 is a water-based urethane, such as CTI 3690, manufactured by the Chemical Technology Inc. Other desired seal coat materials may be used that are compatible with the base material 20. The wire size of the Meyer Rod used was #5-9, the solids of the coating is 50%-60% and line speed used in the operation was 10-20 ft/min. The coating procedure 18 creates a seal coat 30 (shown in FIG. 2) with a 5-10 g/sq ft coating weight.

The seal coat 30 saturates at least a portion the base material 20. That is, the seal coat 30 extends into the void spaces of the base material 20, and does not just remain on the surface of the base material 20. This increases the strength of the bond between the base material 20 and the seal coat 30. It should be appreciated that the seal coat 30 may saturate the whole base material 20, filling all the void spaces in the base material 20. The seal coat material 28 may be colored in order to provide the marking tape 10 with a desired color. The seal coat 30 also provides a seal coat surface 32 that is relatively non-porous across the width of the base material 20. The seal coat surface 32 provides a suitable surface for attaching a carrier coat (described below in reference to FIG. 4).

The base material 20 with the seal coat 30 is dried in a hot air oven 34 at a temperature of 150-250 degrees F. The base material 20 with the seal coat 30 may then be rolled onto an intermediate roll 36. The intermediate roll 36 may then be used for a carrier coating procedure, as described below. Alternatively, the base material 20 with the seal coat 30 may be fed into the carrier coating procedure without placing it in the intermediate roll.

It should be appreciated that while one coating procedure 18 has been described in detail, other coating procedures that provide the desired saturation of the base material 20 and the desired seal coat surface 32 may be used, if desired. This can include using a Meyer rod process with different parameters from those described, or using a different coating procedure, such as a reverse roll coating procedure or immersion coating.

Referring now to FIG. 4, a schematic view of a Meyer Rod carrier coating procedure is shown generally at 38. The carrier coating procedure 18 is one step in a method suitable to create the marking tape 10. In the illustrated carrier coating procedure 38, the base material 20 with the seal coat 30 is unwound from the intermediate roll 36 and fed in the direction indicated by the arrow 40. The base material 20 with the seal coat 30 is passed over a carrier coating roller 42 where a carrier coat material 44 is applied on the seal coat surface 32. Meyer rods 46 are used to control the thickness of the layer of the carrier coat material 44. In the illustrated carrier coating procedure 38, the carrier coat material 44 is a water-based urethane, such as CTI 3690 as manufactured by the Chemical Technology Inc. Other desired carrier coat materials may be used that are compatible with the seal coat material 28. The wire size of Mayer rod used is #7-9, and the solids of the coating is 50%-60%. The carrier coating procedure 38 creates a carrier coat 48 (shown in FIG. 2). The carrier coat 48 may be colored, if desired, and may be the same color as the seal coat 30 or a different color. It should be appreciated that by coloring the carrier coat material 44, the marking tape 10 can retain the desired color as the carrier coat 48 is worn away over use or with time.

A reflective material is applied to the carrier coat 48. The reflective material increases the ability of the marking tape 10 to reflect light. In the illustrated carrier coating procedure 38, the reflective material comprises glass beads 50. The illustrated glass beads 50 are in the 30/50 mesh range and are applied at a rate sufficient to meet the reflectance requirements. The glass beads 50 may be other desired sizes. The glass beads 50 may also be colored, if desired. It should be appreciated that the described embodiment for making the marking tape 10 does not include adding the glass beads 50 to the seal coat 30 because the glass beads 50 could move into the base material 20. The relatively non-porous seal coat surface 32 helps prevent movement of the glass beads 50 into the base material 20. It should be appreciated that the glass beads 50 being embedded throughout the carrier coat 48, rather then just on the surface, allows the marking tape 10 to retain improved reflective characteristics, as compared to the tape without the reflective material, as the carrier coat 48 is worn away over use or with time.

The product is dried in a hot air oven 52 at a temperature of 160-180 degrees F. The carrier coat 48 is then spray coated with a water-based fluorocarbon 54 such as CTI Lube 3352 Mold Release, manufactured by the Chemical Technology Inc. to provide a release layer 56. The typical amount of release agent applied is 0.5-1.5 g/ft. A pressure sensitive adhesive, such as H4202-05X manufactured by Bostik, is applied to provide an adhesive layer 58 on the second side 20b of the base material 20. The adhesive is applied at 100% solids with a slot die coater, to a thickness of 5-15 thousands of an inch. The release layer 56 acts as a release agent to help prevent the glass beads 50 from sticking to the adhesive layer 58 when the marking tape is wound onto a final roll 60.

It should be appreciated that while one carrier coating procedure 38 has been described in detail, other coating procedures that provide the desired carrier coat 48 may be used, if desired. This can include using a Meyer rod process with different parameters from those described, or using a different coating procedure, such as a reverse roll coating procedure or immersion coating.

Additional layers may be added to the marking tape 10 if desired. For example, a third coat similar to the above-described carrier coat 48 may be added on top of the carrier coat 48. The third coat may be added to increase the useful lifespan of the marking tape 10 by increasing the amount of material that may be worn off before the marking tape 10 needs to be replaced.

The marking tape 10 previously described is suitable for use as a highway marking tape, and provides several advantages over conventional highway marking tapes. Conventional marking tapes currently in use utilize nitrile rubbers as the base web. Nitrile rubbers are organic cyanides and can produce highly toxic HCN (hydrogen cyanide) gas as well as carbon monoxide when burned. Conventional marking tapes also use solvent-based materials for coatings. The water-based materials used in the coatings on the marking tape 10 have a lower content of volatile organic compounds, and as a result allow for a safer manufacturing process. The described method for making the marking tape 10 includes materials that contain no hazardous components. The water-based urethanes have MSDS ratings of Health—1, Flammability—1, Reactivity—1, and contain zero VOCs (Volatile Organic Compounds) and zero HAPS (Hazardous Air Pollutants).

The marking tape 10 also offers greater tear resistance than nitrile rubber-based tapes. In particular, the improved cross-machine direction tensile strength of the base material 20 provides the marking tape 10 with an improved resistance to tearing in the cross-wise direction. The marking tape 10 has reduced expansion/contraction over temperature changes than nitrile rubber-based tapes, and it is thinner and more flexible, which allow for greater lineal feet per roll of product than nitrile rubber-based tapes. The improved flexibility of marking tape 10 also allows it to more easily conform to an existing shape, and the marking tape 10 is less likely to retain a memory making it easier to apply the marking tape 10 to a contoured surface.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A marking tape comprising:
a fibrous, non-woven base material having a first side and a second side opposite the first side;
a seal coat that saturates a portion of the non-woven base material and provides a relatively non-porous coat surface;
a carrier coat applied to the coat surface;
a reflective material applied to the carrier coat, wherein the relatively non-porous coat surface is adapted to help prevent movement of the reflective material into the fibrous, non-woven base material; and
an adhesive applied to the second side.

2. The marking tape of claim 1, wherein the non-woven base material has a machine direction tensile strength of at least 90 pounds and a cross-machine direction tensile strength of at least 90 pounds.

3. The marking tape of claim 1, further comprising a release layer applied to the carrier coat, the release layer adapted to prevent the reflective material from sticking to the adhesive.

4. The marking tape of claim 1, wherein the seal coat is comprised of a water-based urethane.

5. The marking tape of claim 4, wherein the seal coat and the carrier coat contain no hazardous components.

6. The marking tape of claim 1, further comprising the reflective material embedded in the carrier coat.

7. The marking tape of claim 6, wherein the non-woven base material has a machine direction tensile strength of at least 90 pounds and a cross-machine direction tensile strength of at least 90 pounds.

8. The marking tape of claim 7, wherein the seal coat and the carrier coat contain no hazardous components.

9. The marking tape of claim 7, further comprising a release layer applied to the carrier coat, the release layer adapted to prevent the reflective material from sticking to the adhesive.

10. The marking tape of claim 1, further comprising a release layer applied to the carrier coat, the release layer adapted to prevent the reflective material from sticking to the adhesive.

11. The marking tape of claim 1, wherein the fibrous, non-woven base material is comprised of polyester.

12. A method of making a marking tape, the method comprising:
a) applying a seal coat to a first side of a fibrous, non-woven base material such the seal coat saturates a portion of the base material and such that the seal coat forms a relatively non-porous coat surface;
b) applying a carrier coat to the relatively non-porous coat surface;
c) applying a reflective material to the carrier coat, wherein the relatively non-porous coat surface is adapted to help prevent movement of the reflective material into the fibrous, non-woven base material; and
d) applying an adhesive to a second side of the fibrous, non-woven base material.

13. The method of claim 12, wherein the fibrous, non-woven base material has a machine direction tensile strength of at least 90 pounds and a cross-machine direction tensile strength of at least 90 pounds.

14. The method of claim 13, wherein the step of applying the seal coat includes applying a water-based urethane to the non-woven base material.

15. The method of claim 14, wherein the step of applying the carrier coat includes applying a water-based urethane to the coat surface.

16. The method of claim 15, wherein the method does not use any materials with hazardous components.

17. The method of claim 12, further comprising applying a release layer to the carrier coat, the release layer adapted to prevent the reflective material from sticking to the adhesive.
